(19) United States
(12) Patent Application Publication
(10) Pub. No.: US 2012/0275484 A1
(43) Pub. Date: Nov. 1, 2012

(54) TEMPERATURE MEASURING DEVICE, TEMPERATURE CALIBRATING DEVICE AND TEMPERATURE CALIBRATING METHOD

(75) Inventors: Masato HAYASHI, Nirasaki City (JP); Koudai HIGASHI, Nirasaki City (JP)

(73) Assignee: TOKYO ELECTRON LIMITED, Tokyo (JP)

(21) Appl. No.: 13/450,042

(22) Filed: Apr. 18, 2012

(30) Foreign Application Priority Data
Apr. 27, 2011 (JP) 2011-098991

(51) Int. Cl. G01K 15/00; G01K 7/16

(52) U.S. Cl. 374/1; 374/185; 374/E07.018; 374/E15.001

(57) ABSTRACT

A temperature measuring device which measures a temperature of a heat treatment mechanism in a heat treatment apparatus which heat-treats a substrate with a predetermined temperature using the heat treatment mechanism, includes: a substrate and a Wheatstone bridge circuit which is disposed on the substrate and includes a plurality of temperature-measuring resistors whose resistance is varied depending on a change in temperature.

### CROSS-REFERENCE TO RELATED APPLICATION

This application claims the benefit of Japanese Patent Application No. 2011-098991, filed on Apr. 27, 2011, in the Japan Patent Office, the disclosure of which is incorporated herein in its entirety by reference.

### TECHNICAL FIELD

The present disclosure relates to a temperature measuring device which measures a temperature of a heat treatment mechanism in a heat treatment apparatus that heat-treats a substrate with a predetermined temperature using the heat treatment mechanism. The present disclosure further relates to a temperature calibrating device which includes the temperature measuring device and calibrates the temperature of the heat treatment mechanism, and to a temperature calibrating method using the temperature calibrating device. In the present disclosure, the term “calibrating” means measuring the temperature of the heat treatment mechanism and adjusting the temperature of the heat treatment mechanism to a desired temperature.

### BACKGROUND

A photolithography process in a semiconductor device manufacturing process includes a variety of heat treatments such as, for example, a heat treatment after coating a resist solution on a semiconductor wafer (hereinafter, referred to as a “wafer”) [Pre-baking], a heat treatment after exposing a predetermined pattern on a resist film [Post-exposure baking], a heat treatment after developing the exposed resist film [Post-baking], etc. After these heat treatments are performed, a heat treatment for adjusting a temperature of the wafer is also carried out. In addition, a heat treatment for adjusting a temperature of the wafer is also carried in a plasma process for etching, film forming and so on.

The above-mentioned heat treatments are carried out, for example when a wafer is loaded on a heat treatment plate set to a predetermined temperature in a heat treatment apparatus. In order to carry out these heat treatments properly, it is important to measure a distribution of temperature of the wafer on the heat treatment plate in advance and correct the set temperature of the heat treatment plate properly based on the result of the measurement. Thus, temperature measurement of the wafer in these heat treatments has been conventionally made.

A method has been proposed for such wafer temperature measurement using a wafer type temperature sensor including a plurality of temperature sensors and a contact point which is disposed on a surface of the wafer and outputs a sensor output of each of the temperature sensors as an output signal. In this case, a contactor provided within the heat treatment apparatus contacts the contact point and the output signal from the contact point is output, via the contactor, to a data management unit provided at the outside of the heat treatment apparatus. Then, the data management unit determines the temperature of the wafer based on the output signal.

However, since the temperature sensors individually contact the contact point on the wafer type temperature sensor in the above-described method, resistances of the temperature sensors are all measured. In this case, the number of data to be managed in the data management unit, that is, the number of temperatures to be measured, greatly increases. This makes control of the wafer temperature very complicated when the temperature of the heat treatment plate is adjusted based on a result of such temperature measurement.

Further, even in the case where a wireless measuring device is used, since the resistances of a plurality of temperature sensors provided on the wafer are all measured, like in the above-described method, control of the wafer temperature is also very complicated.

### SUMMARY

The present disclosure provides a temperature measuring device to calibrate a temperature of a heat treatment mechanism which heat-treats a substrate with a pre-determined temperature in a heat treatment apparatus in a simpler manner. The present disclosure further provides a temperature calibrating device which includes the temperature measuring device. The present disclosure further provides a temperature calibrating method using the temperature calibrating device.

According to one embodiment of the present disclosure, there is provided a temperature measuring device which measures a temperature of a heat treatment mechanism in a heat treatment apparatus which heat-treats a substrate with a predetermined temperature using the heat treatment mechanism, including a substrate, and a Wheatstone bridge circuit which is disposed on the substrate and includes a plurality of temperature-measuring resistors whose resistance is varied depending on a change in temperature.

According to another embodiment of the present disclosure, there is provided a temperature calibrating device which calibrates a temperature of a heat treatment mechanism in a heat treatment apparatus which heat-treats a substrate with a predetermined temperature using the heat treatment mechanism, including a substrate, a Wheatstone bridge circuit which is disposed on the substrate and includes a plurality of temperature-measuring resistors whose resistance is varied depending on a change in temperature, and a controller which adjusts the temperature of the heat treatment mechanism so that the Wheatstone bridge circuit is in an equilibrium condition.

According to yet another embodiment of the present disclosure, there is provided a temperature calibrating method which calibrates a temperature of a heat treatment mechanism using a temperature calibrating device in a heat treatment apparatus which heat-treats a substrate with a predetermined temperature using the heat treatment mechanism, including providing the temperature calibrating device which includes a substrate and a Wheatstone bridge circuit disposed on the substrate, and adjusting the temperature of the heat treatment mechanism so that the Wheatstone bridge circuit is in an equilibrium condition, wherein the Wheatstone bridge circuit includes a plurality of temperature-measuring resistors whose resistance is varied depending on a change in temperature.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is an explanatory view showing a general configuration of a temperature calibrating device and a heat treatment apparatus according to an embodiment of the present disclosure.

FIG. 2 is a plan view showing a general configuration of a heat treatment plate.

FIG. 3 is a plan view showing a general configuration of a temperature inspection jig.

FIG. 4 is an explanatory view showing a general configuration of a Wheatstone bridge circuit.

FIG. 5 is a side view showing a general configuration of the temperature inspection jig.

FIG. 6 is a plan view showing a general configuration of a temperature inspection jig according to another embodiment of the present disclosure.

FIG. 7 is an explanatory view showing an arrangement of a Wheatstone bridge circuit according to another embodiment of the present disclosure.

FIG. 8 is a plan view showing a general configuration of a temperature inspection jig according to another embodiment of the present disclosure.

FIG. 9 is a plan view showing a general configuration of a temperature inspection jig according to another embodiment of the present disclosure.

FIG. 10 is a plan view showing a general configuration of a temperature inspection jig according to another embodiment of the present disclosure.

FIG. 11 is a plan view showing a general configuration of a temperature inspection jig according to another embodiment of the present disclosure.

### DETAILED DESCRIPTION

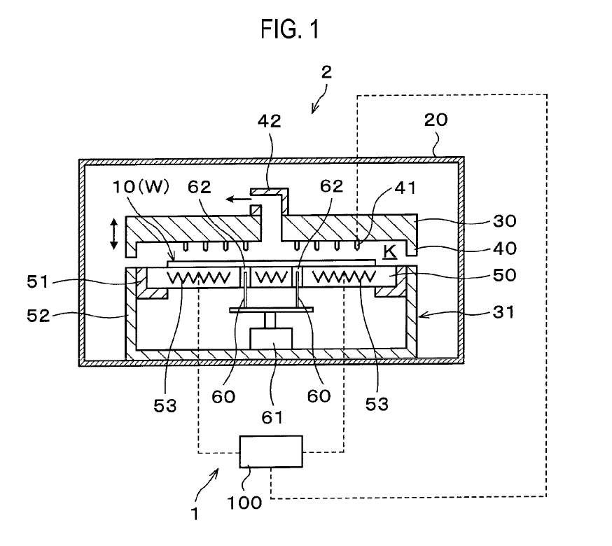

Embodiments of the present disclosure will now be described with reference to the drawings. FIG. 1 is an explanatory view showing a general configuration of a temperature calibrating device 1 and a heat treatment apparatus 2 in which the temperature calibrating device 1 is used, according to an embodiment of the present disclosure. The temperature calibrating device 1 controls a temperature of a heat treatment plate 50 as a heat treatment mechanism (which will be described later) in the heat treatment apparatus 2 and includes a temperature inspection jig 10 which is loaded on the heat treatment plate 50. The heat treatment apparatus 2 heat-treats a wafer W as a substrate, which is loaded on the heat treatment plate 50.

The heat treatment apparatus 2 includes a process container 20 having a side formed with a carry-in/out port (not shown) for the temperature inspection jig 10 and/or the wafer W, as shown in FIG. 1. Inside the process container 20 are provided a cover member 30 which is located in an upper part and can be vertically elevated, and a hot plate receiving unit 31 which is located in a lower part and forms a process chamber K integrated with the cover member 30.

The cover member 30 has a substantially cylindrical shape. A projection 40 is formed on a lower circumference of the cover member 30 and contacts the hot plate receiving unit 31 to form the process chamber K. A plurality of contactors 41, such as pogo pins, extending in a vertically downward direction is provided in the lower side of the cover member 30. The contactors 41 are made of a conductive material. The plurality of contactors 41 is disposed in correspondence (opposite) to contact pads 73 (which will be described later) of the temperature inspection jig 10. An exhaust unit 42 is provided in the upper central part of the cover member 30 and an atmosphere of the process chamber K is uniformly exhausted by the exhaust unit 42.

The hot plate receiving unit 31 includes a ring-like holding member 51 which accommodates the heat treatment plate 50 and holds the circumference of the heat treatment plate 50, and a substantially cylindrical support ring 52 which surrounds the circumference of the holding member 51.

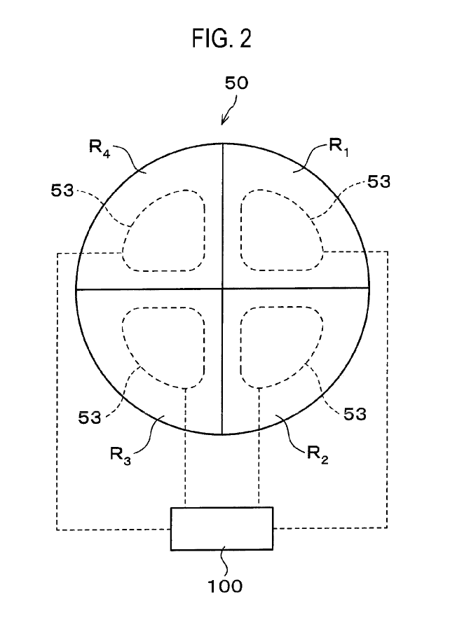

The heat treatment plate 50 is partitioned into several (for example, four) hot plate regions R₁, R₂, R₃ and R₄, as shown in FIG. 2. The heat treatment plate 50 is, for example, quartered when viewed from the top. That is, the hot plate regions R₁, R₂, R₃ and R₄ have a fan shape with their respective central angles of 90 degrees.

Each of the hot plate regions R₁ to R₄ of the heat treatment plate 50 may be heated by corresponding heaters 53 which are disposed in each of the hot plate regions and heated by the supply of electricity. The amount of heat generated by the heaters 53 of the hot plate regions R₁ to R₄ is adjusted by a controller 100, which will be described later. The controller 100 may control the temperature of the hot plate regions R₁ to R₄ to a predetermined temperature by adjusting the amount of heat generated by the respective heaters 53.

As shown in FIG. 1, elevating pins 60 for supporting and elevating the temperature inspection jig 10 or the wafer W from below are provided below the heat treatment plate 50. The elevating pins 60 may be vertically elevated by an elevation driving mechanism 61. Through holes 62 which penetrate through the heat treatment plate 50 in the thickness direction are formed near the central portion of the heat treatment plate 50. The elevating pins 60 may ascend from below to pass through the through holes 62 and may project toward the upper part of the heat treatment plate 50.

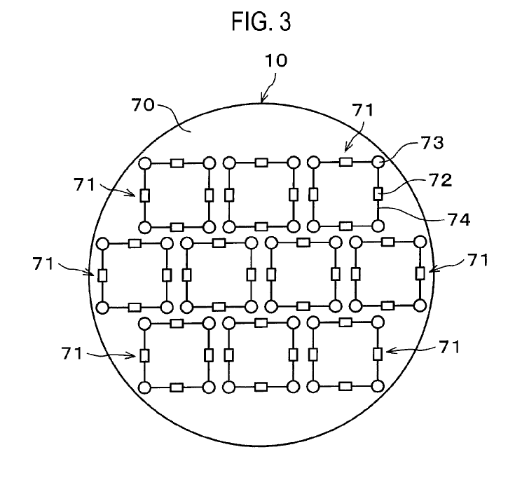

Next, a configuration of the temperature calibrating device 1 will be described. The temperature calibrating device 1 has the temperature inspection jig 10 loaded on the heat treatment plate 50, as shown in FIG. 1. The temperature inspection jig 10 has a targeted wafer 70 as a substrate, as shown in FIG. 3. The targeted wafer 70 is made of the same material as the wafer W, such as silicon, and has the same planar shape as the wafer W. For accurate temperature measurement, the targeted wafer 70 is preferably same as the actual wafer W but, without being limited thereto, it may be different in shape, material and so on from the wafer W. For example, the targeted wafer 70 may be a highly-heat radiating substrate for LEDs. Since this substrate has a high heat resistance and high heat conductivity by using a metal such as Al or Cu as a base substrate, the targeted wafer 70 hardly bends, even under a high temperature environment.

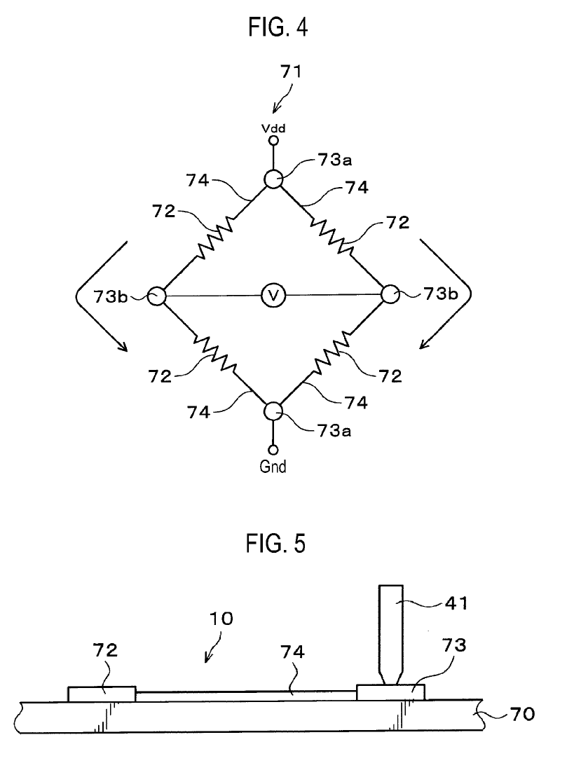

A plurality of Wheatstone bridge circuits 71 is formed on the targeted wafer 70. In this embodiment, the plurality of Wheatstone bridge circuits 71 is arranged in zigzag over substantially the entire surface of the targeted wafer 70. Each of the Wheatstone bridge circuits 71 includes four temperature-measuring resistors 72 and four contact pads 73, which are electrically interconnected by wirings 74, as shown in FIGS. 3 and 4. The temperature-measuring resistors 72, contact pads 73 and wirings 74 are formed at one time by, for example, subjecting the targeted wafer 70 to a photolithography process. If the targeted wafer 70 is conductive, its surface may be processed to have a sufficient insulating part before these elements are formed.

The temperature-measuring resistors 72 are resistors whose resistance varies depending on a change in temperature and may be, for example, resistance temperature detectors (RTDs), thermistors, etc. The temperature-measuring resistors 72 are arranged on temperature measurement points on the targeted wafer 70.

The contact pads 73 make contact with the contactors 41 when adjusting the temperature of the heat treatment plate 50, as shown in FIG. 5. The contact pads 73 are made of a conductive material, for example, aluminum. As shown in FIG. 4, the four contact pads 73 are arranged at apexes of the Wheatstone bridge circuits 71. A pair of contact pads 73 a provided at both ends of a series of two temperature-measuring resistors 72 is used to apply a voltage to the Wheatstone bridge circuits 71. A pair of contact pads 73b provided at a middle point of the series of two temperature-measuring resistors 72 is used to measure a voltage between the contact pads 73b. That is, the contact pads 73b are used to measure an offset voltage in the Wheatstone bridge circuits 71. In FIG. 4, the arrows indicate a current produced when a voltage is applied to the Wheatstone bridge circuits 71.

Like the contact pads 73, the wirings 74 may be made of, for example, aluminum.

The temperature calibrating device 1 includes the controller 100 provided at the outside of the heat treatment apparatus 2, as shown in FIG. 1. The controller 100 is, for example, a computer and has a measurement circuit including, for example, a processor, a memory, an amplifier, a switch and so on. The controller 100 may use this measurement circuit to measure the offset voltage, etc. in the Wheatstone bridge circuits 71. The controller 100 also has a program storage (not shown). The program storage stores a program which adjusts the temperature of the heat treatment plate 50 (the amount of heat generated by the heaters 53) based on the offset voltage in the Wheatstone bridge circuits 71. The program may be a program stored in a computer readable storage medium such as a hard disk (HD), flexible disk (FD), compact disc (CD), magneto-optical disc (MO), memory card or the like, or a program installed from a storage medium to the controller 100. If the heat treatment apparatus 2 has a temperature adjustment mechanism for adjusting the temperature of the heat treatment plate 50, the controller 100 may control the temperature adjustment mechanism based on a measured temperature. A proper action may be taken depending on the functions of the heat treatment apparatus 2.

Next, adjusting the temperature of the heat treatment plate 50 of the heat treatment apparatus 2 using the temperature calibrating device 1 will be described.

First, the temperature inspection jig 10 is carried in the heat treatment apparatus 2. The temperature inspection jig 10 is delivered onto the elevating pins 60 which were ascended in advance and waiting. Thereafter, the elevating pins 60 descend and the temperature inspection jig 10 is loaded on the heat treatment plate 50. At this time, the hot plate regions R₁ to R₄ of the heat treatment plate 50 are adjusted to an initial temperature preset by the controller 100. Thereafter, the cover member 30 descends to a predetermined position and closes. Then, the targeted wafer 70 of the temperature inspection jig 10 loaded on the heat treatment plate 50 is heat-treated.

The contactors 41 contact with the contact pads 73 of the temperature inspection jig 10 loaded on the heat treatment plate 50. When the heat treatment of the targeted wafer 70 is completed, a predetermined voltage is applied to the contact pads 73a on the targeted wafer 70 via the contactors 41. Subsequently, a signal indicating a result of the measurement is output from the contact pads 73b to the controller 100 via the contactors 41. Thus, the controller 100 measures the offset voltage (the voltage between the contact pads 73b) of the Wheatstone bridge circuits 71. Then, the controller 100 adjusts the temperature of the heat treatment plate 50 such that the offset voltages of the plurality of Wheatstone bridge circuits 71 become zero. That is, the controller 100 adjusts the temperature of each of the hot plate regions R₁ to R₄ of the heat treatment plate 50 such that the offset voltages of the plurality of Wheatstone bridge circuits 71 become zero.

The expression “the offset voltages of the plurality of Wheatstone bridge circuits 71 become zero” means that the four temperature-measuring resistors 72 in the Wheatstone bridge circuit 71 have the same resistance. This means that the temperature of the targeted wafer 70 in which the Wheatstone bridge circuits 71 are provided becomes uniform. Accordingly, when the offset voltages of all of the Wheatstone bridge circuits 71 become zero, the temperature of the targeted wafer 70 becomes entirely uniform.

With the temperature of the heat treatment plate 50 adjusted as above, the elevating pins 60 ascend and the temperature inspection jig 10 is carried out of the heat treatment apparatus 2. Thus, the temperature of the heat treatment plate 50 is adjusted.

If the offset voltages of all of the Wheatstone bridge circuits 71 cannot become zero with a single temperature adjustment, the temperature adjustment can be performed several times. That is, the heat treatment of the targeted wafer 70, the measurement of the offset voltages of the Wheatstone bridge circuits 71, and the temperature adjustment of the heat treatment plate 50 are repeated to enable the offset voltages of the Wheatstone bridge circuits 71 to become zero.

According to the above embodiment, the temperature of the heat treatment plate 50 is adjusted such that the Wheatstone bridge circuits 71 formed on the targeted wafer 70 are in an equilibrium condition; that is, the offset voltages of the Wheatstone bridge circuits 71 become zero. In this case, since the offset voltage becomes zero, the four temperature-measuring resistors 72 in the Wheatstone bridge circuits 71 have the same resistance, i.e., the temperature of the targeted wafer 70 measured by the temperature-measuring resistors 72 becomes uniform. In addition, since the offset voltages in all of the Wheatstone bridge circuits 71 on the targeted wafer 70 become zero, the temperature of the targeted wafer 70 corresponding to the Wheatstone bridge circuits 71 becomes uniform. Thus, according to this embodiment, the temperature of the heat treatment plate 50 can be properly adjusted so that the targeted wafer 70 can be uniformly heat-treated in a horizontal plane. In other words, this embodiment is particularly useful for temperature adjustment of the heat treatment plate 50 in which there is no need of absolute temperature adjustment but in which in-plane uniformity of the temperature of the targeted wafer may be secured. Although a set output of the heat treatment plate 50 is generally reliable, variation of the output value is often generated in reality with a lapse of time. In this case, it may be regarded that the temperature adjustment is sufficiently made at the point of time when the in-plane uniformity is secured.

Since each of the Wheatstone bridge circuits 71 have the four temperature-measuring resistors 72, the temperatures at four sites are measured by the conventional method. In the conventional method, these four parameters are used to adjust the temperature of the heat treatment plate 50. In contrast, according to this embodiment, a parameter used to adjust the temperature of the heat treatment plate 50 is only the offset voltage of the Wheatstone bridge circuits 71. Thus, this embodiment uses less number of parameters so that the temperature of the heat treatment plate 50 can be adjusted with simpler control. Accordingly, it is possible to decrease a load applied to the heaters 53 of the heat treatment plate 50 while carrying out the temperature adjustment of the heat treatment plate 50 in a short time.

When the resistance of a temperature-measuring resistor is measured, if normal two-line connection type or four-line connection type is used, two or four contact pads (two or four wirings) are provided for each of the temperature-measuring resistors. In contrast, in the Wheatstone bridge circuit 71 of this embodiment, four contact pads 73 (four wirings 74) are provided for the four temperature-measuring resistors 72. Thus, according to this embodiment, the number of contact pads 73 and wirings 74 can be reduced.

The heat treatment plate 50 is partitioned into the plurality of hot plate regions R₁ to R₄ in which the respective heaters 53 are incorporated. Accordingly, the temperatures of the hot plate regions R₁ to R₄ can be independently adjusted to achieve an accurate temperature adjustment of the heat treatment plate 50.

Although in the above embodiment, the offset voltage in the Wheatstone bridge circuit 71 is used as a parameter for the temperature adjustment of the heat treatment plate 50, a current value in the Wheatstone bridge circuits 71 may be used as a parameter in addition to the offset voltage.

In this case, in the heat treatment apparatus 2, after the temperature inspection jig 10 loaded on the heat treatment plate 50 is heat-treated, the current value of the Wheatstone bridge circuits 71 in the temperature inspection jig 10 is measured in addition to the offset voltage of the Wheatstone bridge circuits 71. Then, the temperature of the heat treatment plate 50 by the controller 100 is adjusted such that offset voltages of all of the Wheatstone bridge circuits 71 become zero and the current values of all of the Wheatstone bridge circuits 71 become equal to each other at a predetermined value.

According to this embodiment, the resistances of the temperature-measuring resistors 72 in all of the Wheatstone bridge circuits 71 on the targeted wafer 70 can become equal to each other at a predetermined value. Accordingly, the temperature of the heat treatment plate 50 can be adjusted so that the targeted wafer 70 can be uniformly heat-treated at a predetermined temperature. Even in this case, the number of parameters for the temperature adjustment of the heat treatment plate 50 is two (i.e., the offset voltage and current value of the Wheatstone bridge circuits 71), and the temperature of the heat treatment plate 50 can be adjusted in a simpler manner than the conventional method.

In the above embodiment, the controller 100 may store a table (not shown) showing, for example, a relationship between the current value in the Wheatstone bridge circuits 71 and the temperature of the targeted wafer 70. In this case, the controller 100 measures the temperature of the targeted wafer 70 using the table and based on the measured current value of the Wheatstone bridge circuits 71. Thus, the absolute temperature of the targeted wafer 70 after the heat treatment can be detected.

In addition, one of the four temperature-measuring resistors 72 in the Wheatstone bridge circuits 71 may be replaced with a fixed resistor having predetermined resistance. The fixed resistor may be a resistor whose change in resistance is zero or negligible with respect to a change in temperature. For example, a Wheatstone bridge circuit 71 composed of one 1385Ω fixed resistor and three Pt1000s (temperature-measuring resistors 72) is prepared. It can be seen that Pt1000 has a resistance of 1385Ω at 100 degrees C. In this case, if only the offset voltage of the Wheatstone bridge circuit 71 is controlled to become zero, the remaining three temperature-measuring resistors 72 have resistance of 1385Ω. That is, the three temperature-measuring resistors 72 are controlled to be at 100 degrees C. Although a temperature at a site where a fixed resistor is placed cannot be measured, an absolute temperature control is possible without measuring the current value. Accordingly, this method is highly effective when the temperature (to be controlled) of the heat treatment plate 50 is predetermined In addition, the number of fixed resistors is not limited to one but may be two or more.

In the above embodiment, it is regarded that the resistances of the four temperature-measuring resistors 72 become equal to each other when the offset voltage of the Wheatstone bridge circuit 71 becomes zero. However, in reality, if two left temperature-measuring resistors 72 of the Wheatstone bridge circuits 71 have the same resistance and two right temperature-measuring resistors 72 of the Wheatstone bridge circuits 71 have the same resistance, the offset voltage becomes zero even if the left temperature-measuring resistors 72 are different in resistance from the right temperature-measuring resistors 72. For example, the offset voltage becomes zero when the left temperature-measuring resistors 72 have a resistance of 1000Ω and the right temperature-measuring resistors 72 have a resistance of 980Ω. In this case, it may be recognized that the four temperature-measuring resistors 72 in the Wheatstone bridge circuit 71 have the same temperature although the left temperature-measuring resistors 72 are different in temperature from the right temperature-measuring resistors 72. To avoid this problem, it is effective to change the measurement sites of the offset voltage of the Wheatstone bridge circuit 71. First, the offset voltage is measured and is controlled to become zero. This is the same as described in the above embodiment. Here, under the condition where the contact pads 73a and 73b on the targeted wafer 70 are in contact with the contactors 41, a measurement of a second offset voltage is made. Although a voltage has been applied between the contact pads 73a in the above embodiment, a voltage is applied between the contact pads 73b in the present embodiment. Subsequently, the offset voltage of the Wheatstone bridge circuits 71 (the voltage between the contact pads 73) is measured from the contact pads 73a through the contactors 41. If the second offset voltage (the voltage between the contact pads 73a) is also zero, the four temperature-measuring resistors 72 in the Wheatstone bridge circuits 71 have the same temperature. The measurement of the second offset voltage in the Wheatstone bridge circuits 71 may be set at any timing. The measurement of the second offset voltage may be carried out immediately after the first offset voltage is measured, or may be carried out for confirmation after the offset voltage is set to zero.

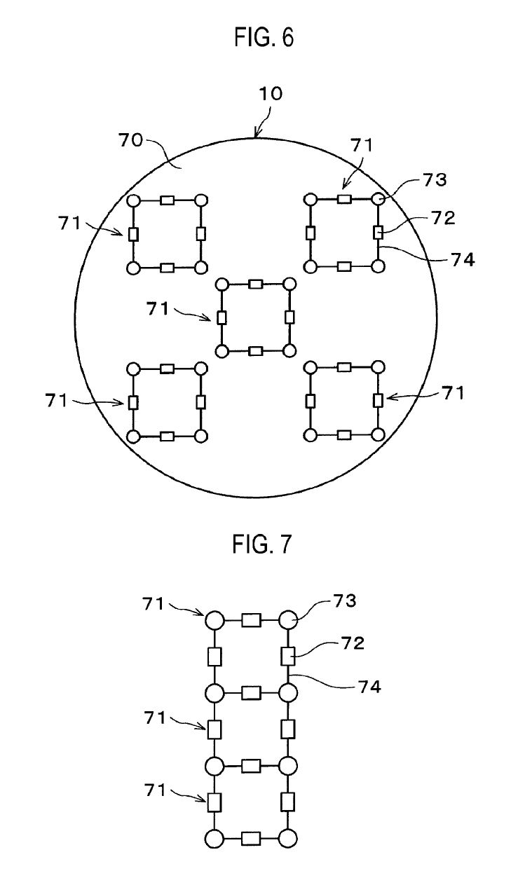

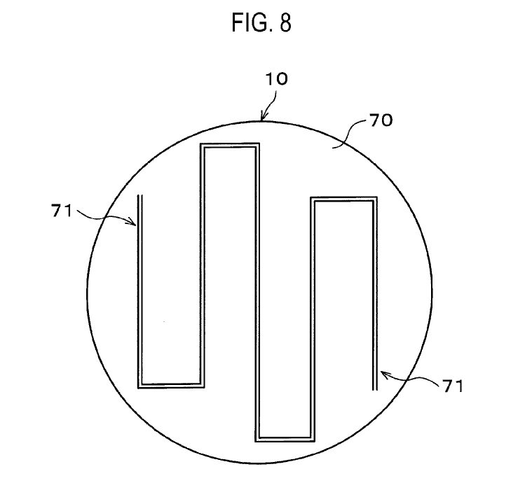

Although it has been illustrated in the above embodiments that the plurality of Wheatstone bridge circuits 71 is arranged in zigzag on the targeted wafer 70, the arrangement of the plurality of Wheatstone bridge circuits 71 is not limited thereto. For example, as shown in FIG. 6, the plurality of Wheatstone bridge circuits 71 may be arranged in the form of a lattice on the targeted wafer 70. As another example, the plurality of Wheatstone bridge circuits 71 may be arranged in a consecutive manner, as shown in FIG. 7, or may be arranged in a winding manner on the targeted wafer 70, as shown in FIG. 8. In both cases, the temperature of the heat treatment plate 50 can be adjusted such that the targeted wafer 70 can be uniformly heat-treated based on the offset voltage or both the offset voltage and current value of the Wheatstone bridge circuits 71.

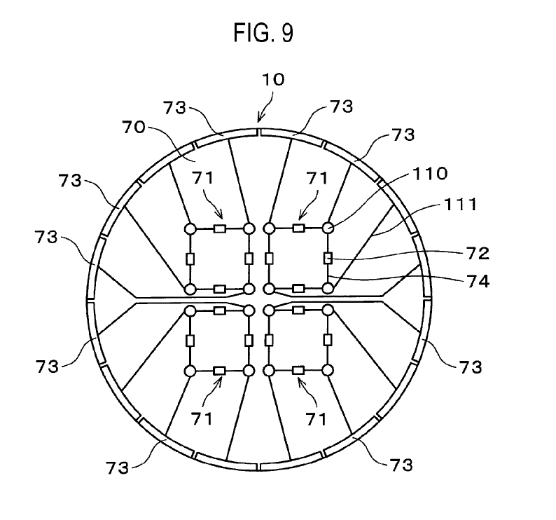

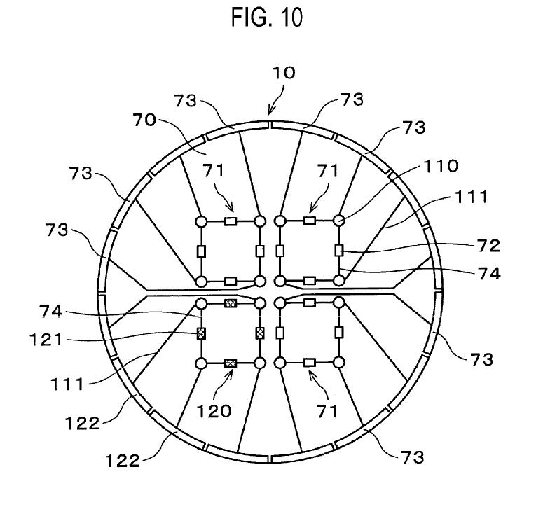

In addition, although it has been illustrated in the above embodiments that the plurality of contact pads 73 is arranged on the apexes of the Wheatstone bridge circuits 71, the plurality of contact pads 73 may be arranged along the circumference of the targeted wafer 70, for example, as shown in FIG. 9. In this case, metal pads 110 connected to two wirings 74 are arranged on the apexes in the Wheatstone bridge circuits 71 and are respectively connected to the contact pads by wirings 111. The metal pads 110 and the wirings 111 are made of a conductive material, for example, aluminum. In the present embodiment, since the contactors do not make contact with the metal pads 110, direct connection between the wirings 74 and the wirings 111 may be made without the metal pads 110.

The targeted wafer 70 may be loaded on the heat treatment plate 50, with the wafer 70 rotated from a predetermined position in a horizontal plane, when the temperature inspection jig 10 is carried into the heat treatment apparatus. Even in this case, since the contact pads 73 are arranged in a consecutive manner along the circumference of the targeted wafer 70, the contactors 41 can make reliable contact with the contact pads 73. This ensures reliable measurement of the offset voltage and current value of the Wheatstone bridge circuits 71 and hence proper adjustment of the temperature of the heat treatment plate 50.

In addition, since the contact pads 73 are arranged along the circumference of the targeted wafer 70 separated from the temperature-measuring resistors 72, the temperature-measuring resistors 72 are unaffected by a change in temperature due to the contact of the contactors 41 with the contact pads 73. This ensures more reliable measurement of the offset voltage and current value of the Wheatstone bridge circuits 71.

In another embodiment, one of the plurality of Wheatstone bridge circuits 71 may be a reference Wheatstone bridge circuit 120, as shown in FIG. 10. The reference Wheatstone bridge circuit 120 has four reference resistors 121 instead of the four temperature-measuring resistors 72. The reference resistors 121 have a resistance which does not vary depending on a change in temperature and is different by more than a predetermined value, for example, 300Ω, from the resistance of the temperature-measuring resistors 72. In addition, the reference Wheatstone bridge circuit 120 has four reference contact pads 122 instead of the four contact pads 73. The plurality of contact pads 73 and reference contact pads 122 are arranged in a consecutive manner along the circumference of the targeted wafer 70. Other configurations of the reference Wheatstone bridge circuit 120 are the same as the corresponding configurations of the Wheatstone bridge circuits 71 in the above embodiments, and therefore, explanation of which will not be repeated.

In this manner, since the reference resistors 121 have a resistance which does not vary depending on a change in temperature and is different by more than a predetermined value from the resistance of the temperature-measuring resistors 72, the resistance of the temperature-measuring resistors 72 measured during the heat treatment of the targeted wafer 70 can be differentiated from the resistance of the reference resistors 121. This allows the controller 100 to detect the positions of the reference resistors 121 relative to the heat treatment plate 50 and hence detect the positions of the other temperature-measuring resistors 72, which may result in the detection of a position of the targeted wafer 70 on the heat treatment plate 50 in a horizontal plane. That is, it is possible to match positions of the reference resistors 121 and the temperature-measuring resistors 72 to the hot plate regions R₁ to R₄ of the heat treatment plate 50. Thus, according to this embodiment, the temperature of the heat treatment plate 50 can be properly adjusted for each of the hot plate regions R₁ to R₄.

Although it has been illustrated in the above embodiments that the contactors 41 make contact with the contact pads 73 of the temperature inspection jig 10 when the offset voltage and current value of the Wheatstone bridge circuits 71 are measured, the spirit of the present disclosure may be applied to other various temperature inspection jigs having Wheatstone bridge circuits.

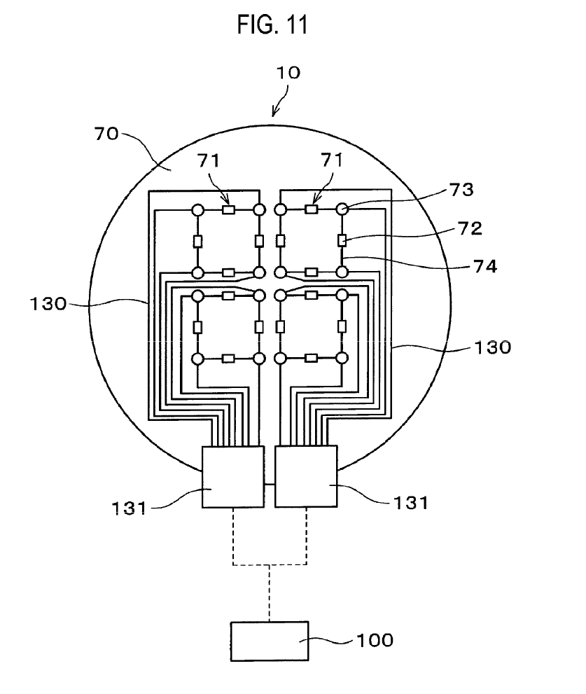

For example, as shown in FIG. 11, a wire type temperature inspection jig 10 may be used. The contact pads 73 of this temperature inspection jig 10 are connected to a flexible cable 131 via wirings 130. The flexible cable 131 is connected to the controller 100. In this embodiment, there is no need for the contactors 41 to make contact with the contact pads 73 when the offset voltage and current value of the Wheatstone bridge circuits 71 are measured. Accordingly, direct connection between the wirings 74 and the wirings 111 may be made without the contact pads 73. In addition, the contactors 41 provided in the lower side of the cover member 30 may not be needed.

In this case, the temperature inspection jig 10 is disposed inside the heat treatment apparatus 2 and the controller 100 is disposed outside the heat treatment apparatus 2. Under these conditions, the targeted wafer 70 is subjected to the heat treatment and then, the offset voltage and current value of the Wheatstone bridge circuits 71 are measured.

In addition, although it has been illustrated in this embodiment that a measurement circuit for the wire type temperature inspection jig 10 is provided in the controller 100, the measurement circuit may be provided on the targeted wafer 70.

Alternatively, a wireless type temperature inspection jig may be used as the temperature inspection jig 10. In this case, the measurement circuit (not shown) can be provided on the targeted wafer 70 instead of being provided in the controller 100. Thus, the offset voltage and current value of the Wheatstone bridge circuits 71 are output from the measurement circuit to the controller 100 wirelessly.

In this manner, either wire type or wireless type temperature inspection jigs 10 may be used to adjust the temperature of the heat treatment plate 50 based on the offset voltage or both the offset voltage and current value of the Wheatstone bridge circuits 71 so that the targeted wafer 70 can be uniformly heat-treated.

Although it has been illustrated in the embodiments that the heat treatment plate 50 is partitioned into four hot plate regions R₁ to R₄, the number of hot plate regions may be changed. In addition, the shape of the hot plate regions R₁ to R₄ of the heat treatment plate 50 may be changed.

The heat treatment performed in the heat treatment apparatus 2 according to the above embodiments may be a heat treatment in a photolithography process, or a heat treatment in a plasma process for etching, film forming and so on. In this case, heat transferred to the wafer W is not limited to heat from the heat treatment plate 50 but may include heat transferred from etching gas or plasma.

According to an embodiment of the present disclosure, the temperature of the heat treatment mechanism can be adjusted so that the Wheatstone bridge circuit formed on the substrate in the temperature measuring device can be in equilibrium condition, that is, the offset voltage in the Wheatstone bridge circuit becomes zero. In this case, since the offset voltage becomes zero, resistances of the plurality of temperature-measuring resistors in the Wheatstone bridge circuit, that is, temperatures of the substrate to be measured by the temperature-measuring resistors, become equal to each other. Thus, the temperature of the heat treatment mechanism can be properly adjusted so that the substrate is uniformly heat-treated in a horizontal plane. In addition, heat treatment for a subsequent substrate can be properly performed by the heat treatment mechanism with such adjusted temperature.

In the conventional method, since the temperature measurement in the plurality of regions on the substrate requires the plurality of temperature-measuring resistors, the temperatures are measured at a plurality of sites according to the number of temperature-measuring resistors. This requires temperature adjustment of the heat treatment mechanism using a plurality of parameters. In contrast, according to one embodiment of the present disclosure, only the offset voltage of the Wheatstone bridge circuit is needed as a parameter to adjust the temperature of the heat treatment plate. Thus, this embodiment uses the less number of parameters so that the temperature of the heat treatment plate can be adjusted with simpler control.

That is, according to an embodiment of the present disclosure, it is possible to calibrate the temperature of the heat treatment mechanism with simpler control in the heat treatment apparatus which heat-treats a substrate with a predetermined temperature using the heat treatment mechanism.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures. The spirit of the present disclosure may be applied to flat panel displays (FPDs) and other various substrates such as mask reticles for photo mask in addition to the wafer.

What is claimed is:

1. A temperature measuring device which measures a temperature of a heat treatment mechanism in a heat treatment apparatus which heat-treats a substrate with a predetermined temperature using the heat treatment mechanism, comprising:
a substrate; and
a Wheatstone bridge circuit which is disposed on the substrate and includes a plurality of temperature-measuring resistors whose resistance is varied depending on a change in temperature.

2. The temperature measuring device of claim 1, wherein the Wheatstone bridge circuit includes a fixed resistor having a predetermined resistance.

3. A temperature calibrating device which calibrates a temperature of a heat treatment mechanism in a heat treatment apparatus which heat-treats a substrate with a predetermined temperature using the heat treatment mechanism, comprising:
a substrate;
a Wheatstone bridge circuit which is disposed on the substrate and includes a plurality of temperature-measuring resistors whose resistance is varied depending on a change in temperature; and
a controller which adjusts the temperature of the heat treatment mechanism so that the Wheatstone bridge circuit is in an equilibrium condition.

4. The temperature calibrating device of claim 3, wherein a plurality of Wheatstone bridge circuits is provided, and
wherein the controller adjusts the temperature of the heat treatment mechanism so that the plurality of Wheatstone bridge circuits is in an equilibrium condition.

5. The temperature calibrating device of claim 3, wherein the controller adjusts the temperature of the heat treatment mechanism so that a current value in the Wheatstone bridge circuit is set to a predetermined value.

6. The temperature calibrating device of claim 3, wherein a plurality of Wheatstone bridge circuits is provided, and
wherein the controller adjusts the temperature of the heat treatment mechanism so that current values in the plurality of Wheatstone bridge circuits become equal to each other.

7. The temperature calibrating device of claim 3, wherein the Wheatstone bridge circuit includes a fixed resistor having a predetermined resistance.

8. The temperature calibrating device of claim 3, wherein the controller measures offset voltages at different sites on the Wheatstone bridge circuit, and adjusts the temperature of the heat treatment mechanism so that the Wheatstone bridge circuit is in an equilibrium condition for each of the measured offset voltages.

9. The temperature calibrating device of claim 3, wherein a plurality of Wheatstone bridge circuits is provided, and
wherein the plurality of Wheatstone bridge circuits is arranged in zigzag, in a form of a lattice, or in a consecutive and winding manner.

10. The temperature calibrating device of claim 3, wherein the heat treatment mechanism is partitioned into a plurality of regions whose temperatures can be controlled.

11. A temperature calibrating method which calibrates a temperature of a heat treatment mechanism using a temperature calibrating device in a heat treatment apparatus which heat-treats a substrate with a predetermined temperature using the heat treatment mechanism, comprising:
providing the temperature calibrating device which includes a substrate and a Wheatstone bridge circuit disposed on the substrate; and
adjusting the temperature of the heat treatment mechanism so that the Wheatstone bridge circuit is in an equilibrium condition,
wherein the Wheatstone bridge circuit includes a plurality of temperature-measuring resistors whose resistance is varied depending on a change in temperature.

12. The temperature calibrating method of claim 11, comprising:
providing a plurality of Wheatstone bridge circuits; and
adjusting the temperature of the heat treatment mechanism so that the plurality of Wheatstone bridge circuits is in an equilibrium condition.

13. The temperature calibrating method of claim 11, comprising:
adjusting the temperature of the heat treatment mechanism so that a current value in the Wheatstone bridge circuit is set to a predetermined value.

14. The temperature calibrating method of claim 11, comprising:
providing a plurality of Wheatstone bridge circuits; and
adjusting the temperature of the heat treatment mechanism so that current values in the plurality of Wheatstone bridge circuits become equal to each other.

15. The temperature calibrating method of claim 11, wherein the Wheatstone bridge circuit includes a fixed resistor having a predetermined resistance.

16. The temperature calibrating method of claim 11, comprising:
measuring offset voltages at different sites on the Wheatstone bridge circuit; and
adjusting the temperature of the heat treatment mechanism so that the Wheatstone bridge circuit is in an equilibrium condition for each of the measured offset voltages.

17. The temperature calibrating method of claim 11, wherein the heat treatment mechanism is partitioned into a plurality of regions, and
wherein the temperature of each of the regions in the heat treatment mechanism is adjusted.
